(19) United States
(12) Patent Application Publication
(10) Pub. No.: US 2026/0128432 A1
(43) Pub. Date: May 7, 2026

(54) ROTARY BODY AND MANUFACTURING METHOD THEREFOR

(71) Applicant: Panasonic Intellectual Property Management Co., Ltd., Osaka (JP)

(72) Inventors: TADAYOSHI TAKAHASHI, Osaka (JP); TOMOHIRO UEDA, Osaka (JP)

(21) Appl. No.: 19/117,879

(22) PCT Filed: Aug. 22, 2023
(86) PCT No.: PCT/JP2023/030173

§ 371 Date: Apr. 2, 2025

(30) Foreign Application Priority Data
Oct. 11, 2022 (JP) 2022-163464

(51) Int. Cl. H01M 50/202; H01M 10/46; H01M 50/109; H01M 50/119; H01M 50/249; H02J 50/10

(52) U.S. Cl. CPC H01M 50/202; H01M 10/46; H01M 50/109; H01M 50/119; H01M 50/249; H02J 50/10

(57) ABSTRACT

A rotary body includes a rotary part and a device fixed to the rotary part. The device includes a substrate, a power receiver, and a flat secondary battery attached to the substrate. The power receiver has a structure for receiving power supply using electromagnetic induction. The secondary battery includes an exterior body including a positive electrode can having a bottomed cylindrical shape and a negative electrode can having a bottomed cylindrical shape. The secondary battery is disposed closer to a rotation center of the rotary part than the substrate as viewed from the rotation center of the rotary part.

### TECHNICAL FIELD

The present disclosure relates to a rotary body including a rotary part to which a device including a flat secondary battery is fixed, and a method for manufacturing the rotary body.

### BACKGROUND ART

A factory automation device (hereinafter, referred to as an FA device) includes a rotary part to which a device for monitoring a position state of the rotary part such as a camera, a motor, or a drill, may be attached. Additionally, a device for monitoring a state of a tire may be attached to the tire. Various methods for attaching a battery used for these devices have been proposed.

PTL 1 (Unexamined Japanese Patent Publication No. 2011-014452) describes Claim 1 as “A method for attaching a flat battery used in a device including a substrate and attached to a tire, the method comprising: disposing the flat battery closer to a rotation center of the tire than the substrate as viewed from a rotation center of the tire”.

PTL 2 (International Publication No. WO 2017/155035) describes Claim 1 as “A tire air pressure detection system disposed in a tire, the tire air pressure detection system comprising: an air pressure detector that detects air pressure in the tire; and a secondary battery that supplies electric power to the air pressure detector, wherein the secondary battery is a lithium secondary battery including a negative electrode having a lithium alloy as an active material and a positive electrode”.

### CITATION LIST

### Patent Literature

PTL 1: Unexamined Japanese Patent Publication No. 2011-014452

PTL 2: International Publication No. WO 2017/155035

### SUMMARY OF THE INVENTION

There are various rotary parts to which centrifugal force is applied, such as a robot arm of a factory automation device (i.e., an FA device), a surveillance camera, a motor, and a tire. Although information acquired by a sensor in the rotary part is important, use of a secondary battery has been studied to maintain the acquired information due to reasons such as sudden disconnection of electric wiring and frequent replacement of a primary battery. PTL 1 proposes a method for attaching a battery to a substrate in a device attached to a rotary part as a method for suppressing breakage of components inside the battery due to external impact and vibration caused by traveling of an automobile. However, in PTL 1, influence of charging and discharging of a secondary battery is not taken into account. Although PTL 2 proposes a lithium secondary battery in which a lithium alloy is used as a negative electrode active material for a tire pressure monitoring system power supply, evaluation is performed on a unit cell. The flat lithium secondary battery is not evaluated in a state of being used in an actual device and being electrically connected to the substrate by the terminal.

A device fixed to a rotary body according to the present disclosure does not require battery replacement, and has high long-term reliability suitable for monitoring a state of a rotary part.

A rotary body according to an aspect of the present disclosure includes a rotary part configured to rotate about a rotation center, and a device fixed to the rotary part. The device includes a substrate, a power receiver, and a flat secondary battery attached to the substrate. The power receiver has a structure for receiving power supply using electromagnetic induction. The flat secondary battery includes an exterior body including a positive electrode can having a bottomed cylindrical shape and a negative electrode can having a bottomed cylindrical shape. The flat secondary battery is disposed closer to the rotation center than the substrate as viewed from the rotation center of the rotary part.

A method for manufacturing a rotary body according to another aspect of the present disclosure includes preparing a device including a substrate, a power receiver, and a flat secondary battery attached to the substrate. The method includes preparing a rotary part configured to rotate about a rotation center. The method also includes fixing the device to the rotary part. The power receiver has a structure for receiving power supply using electromagnetic induction. The flat secondary battery includes an exterior body including a positive electrode can having a bottomed cylindrical shape and a negative electrode can having a bottomed cylindrical shape. The fixing the device to the rotary part includes fixing the device to the rotary part with the flat secondary battery disposed closer to the rotation center than the substrate as viewed from the rotation center of the rotary part.

The present disclosure provides a rotary body to which a device is fixed, the device having high long-term reliability suitable for monitoring a state of a rotary part.

### BRIEF DESCRIPTION OF THE DRAWINGS

FIG. 1 schematically illustrates an example of a device and a rotary part according to a first exemplary embodiment.

FIG. 2A is a top view schematically illustrating an example of a flat secondary battery used in the device according to the first exemplary embodiment.

FIG. 2B schematically illustrates a cross section of the flat secondary battery of FIG. 2A, taken along line IIB-IIB.

FIG. 3 is a diagram schematically illustrating a configuration of the example of the device according to the first exemplary embodiment.

### DESCRIPTION OF EMBODIMENT

Although an exemplary embodiment according to the present disclosure will be described below with reference to an example, the present disclosure is not limited to the example described below. Although specific numerical values and materials may be provided as examples in the description below, other numerical values and materials may be applied as long as effect of the present disclosure can be obtained. When examples of components or examples of methods are listed in the description below, only one of the listed examples may be used, or a plurality of the listed examples may be used in combination unless otherwise specified.

### Device Attached to Rotary Part

A device according to the present exemplary embodiment is attached to a rotary part. The device may be referred to below as “device (D)”. Device (D) includes a substrate, a power receiver, and a flat secondary battery attached to the substrate. The power receiver has a structure for receiving power supply using electromagnetic induction. The flat secondary battery includes an exterior body including a positive electrode can having a bottomed cylindrical shape and a negative electrode can having a bottomed cylindrical shape. The flat secondary battery is disposed closer to a rotation center of the rotary part than the substrate is as viewed from the rotation center of the rotary part. The positive electrode can may face the substrate, or the negative electrode can may face the substrate. In a preferred example, the positive electrode can faces the substrate. That is, in the preferred example, the positive electrode can is disposed between the negative electrode can and the substrate.

Device (D) includes the flat secondary battery disposed closer to the rotation center of the rotary part than the substrate is as viewed from the rotation center of the rotary part. The power receiver that receives power supply from the outside using electromagnetic induction such as magnetic resonance or magnetic field coupling is preferably disposed farther away than the substrate is as viewed from the rotation center of the rotary part.

The power receiver is preferably disposed farther away than the substrate, because an electromagnetic induction power feeder used for charging the secondary battery is disposed outside of the rotation center and power to be supplied is inversely proportional to distance. In addition, exterior cans (i.e., the positive electrode can and the negative electrode can) of the flat secondary battery has magnetism. Thus, by disposing each exterior can closer to the inside than the substrate to be away from the power feeder, the exterior can is prevented from being heated by supplied magnetic flux (i.e., magnetic field). As a result, a temperature rise to a temperature equal to or higher than ambient environment temperature due to electromagnetic induction heating can suppressed, and significant deterioration and swelling of the flat secondary battery can be reduced. The exterior can is made of a material of iron, stainless steel, a corrosion-resistant metal, or a clad material of stainless steel and a corrosion-resistant metal, or is formed by processing a plated product of the material. The exterior can has magnetism generated from the material itself or by processing a product of the material.

In Device (D), it is more preferable that the positive electrode can faces the substrate, and that the negative electrode can disposed closer to the rotation center than the positive electrode can from the viewpoint of deterioration of characteristics of the secondary battery. That is, it is preferable that the positive electrode can is preferably located between the negative electrode can and the substrate. In this configuration, the negative electrode can is prevented from being heated by magnetic flux (i.e., magnetic field) supplied from the outside of the rotary part for power supply using electromagnetic induction. These effects enable suppressing characteristic deterioration due to reaction between the negative electrode and an electrolyte. With regard to reaction between an electrode active material of each of the positive electrode and the negative electrode and the electrolyte, reaction (i.e., reduction) between the negative electrode and the electrolyte to be likely to occur at high temperature causes. Thus, battery characteristics can be maintained by suppressing the reaction of the negative electrode and the swelling of the battery.

The positive electrode can and the negative electrode can may be each independently made of a material that is at least one selected from a group consisting of austenitic stainless steel, two-phase stainless steel composed of austenitic stainless steel and ferritic stainless steel, and nickel alloy. The material of the positive electrode can and the negative electrode can may be same as or different from each other. Examples of the austenitic stainless steel include SUS301, SUS304, SUS305, SUS310, SU316, and SUS316L. Examples of the two-phase stainless steel include SUS329J1, SUS329J3L, and SUS329J4L. Examples of the nickel alloy include 23Cr-35Ni-7.5Mo-0.2N and 23Cr-25Ni-5.5Mo-0.2N. These materials have weaker magnetism than other materials. By using the exterior cans (i.e., the positive electrode can and the negative electrode can) each made of a material having weak magnetism, the exterior cans is prevented from being heated by magnetic flux supplied for power supply by using electromagnetic induction. As a result, deterioration of the flat secondary battery due to a temperature rise can be further suppressed. One of the exterior cans may be made of the material having weak magnetism for the effect. For example, the negative electrode can is made of the material. It is more preferable that both of the exterior cans are made of the material having weak magnetism. As described above, the above configuration makes it possible to provide a rotary body to which a device is fixed, the device having high long-term reliability suitable for monitoring a state of a rotary part.

The rotary part may be provided in a machine. The machine is not particularly limited as long as the machine includes a rotary part to which device (D) is attached.

Examples of the machine include a transport machine, a manufacturing machine, a measuring machine, a machine tool, and other machines. Examples of the transport machine include automobiles (e.g., a four-wheel automobile, a tricycle automobile, a motorcycle, and other automobiles). Examples of the manufacturing machine include a factory automation device (i.e., an FA device) and other manufacturing machines.

The rotary part may be a tire. For the tire, device (D) can be used in a tire monitoring system (TMS) for monitoring pressure in the tire (i.e., tire pressure monitoring system: TPMS), monitoring temperature in the tire, and monitoring acceleration of the tire, and for another monitoring. Depending on a purpose of the monitoring, device (D) includes an electronic component such as a required sensor.

When the rotary part is a tire, device (D) is fixed to an inner surface of the tire (i.e., a surface that is not exposed to outside air during use). For example, device (D) may be fixed to a wheel, a valve, a surface opposite to a ground contact surface of a tread surface of a tire, or an inner surface of a sidewall surface. A method for fixing device (D) to the tire is not limited.

The tire is not particularly limited, and may be a known tire. The tire may be a tire used for various transportation machines, or may be another tire.

The rotary part may be provided in a factory automation device (i.e., an FA device). For the rotary part, device (D) can be used for monitoring the rotary part and/or a surrounding situation with a camera, for monitoring a position of the rotary part, for monitoring temperature of the rotary part, and for another monitoring. Depending on a purpose of the monitoring, device (D) includes an electronic component such as a required sensor.

For the rotary part, a factory automation device (i.e., an FA device) is more preferable than a tire because the FA device is not affected at all by breakage of components inside a battery due to external impact or vibration. For the tire, the wheel and the valve are more preferable than the tread surface and the sidewall surface of the tire because the wheel and the valve are less affected by external impact or vibration than the surfaces. The factory automation device (i.e., an FA device) is preferable as the rotary part also from the viewpoint of temperature change impact of surrounding environment because the FA device operates continuously and has less temperature change than the tire. As the temperature change impact increases, variation in charging efficiency and degradation reaction during charging and discharging of a secondary battery are more likely to be accelerated. When a factory automation device (i.e., an FA device) is used in a manned environment, the FA device has a maximum ambient environment at about 40° C., and has a temperature reaching to 70° C. or 85° C. when the device is continuously used. When the device is used in a special unmanned environment, the device has a temperature reaching to 105° C., 125° C., or 150° C. For example, a temperature of a drill may reach such a temperature. Even a tire has a temperature reaching to 105° C., 125° C., or 150° C. depending on road surface temperature and a rotation state.

Device (D) may be fixed at any position of the rotary part. For example, device (D) may be disposed near an outer periphery of the rotary part. A method for fixing device (D) to the rotary part is not limited.

The battery may be mounted on the substrate using a battery holder (similarly, in attachment method (M) described below). Alternatively, a terminal may be provided on the flat secondary battery, and the terminal may be mounted on the substrate (similarly, in attachment method (M) described below).

### Method for Attaching Flat Secondary Battery

An attachment method according to the present exemplary embodiment is a method for attaching a flat secondary battery used in a device including a substrate and attached to a rotary part. The attachment method may be referred to below as “attachment method (M)”. The rotary body includes a rotary part and device (D) fixed to the rotary part, and is manufactured by preparing device (D), preparing the rotary part, and fixing device (D) to the rotary part. Device (D) includes a power receiver, and a flat secondary battery attached to a substrate. The power receiver has a structure for receiving power supply using electromagnetic induction. The flat secondary battery includes an exterior body including a positive electrode can having a bottomed cylindrical shape and a negative electrode can having a bottomed cylindrical shape. The flat secondary battery is disposed closer to a rotation center of the rotary part than the substrate is as viewed from the rotation center of the rotary part. The positive electrode can may face the substrate, or the negative electrode can may face the substrate. In one preferable example, the positive electrode can faces the substrate. As described above, the power receiver is preferably disposed farther away the substrate as viewed from the rotation center of the rotary part.

Attachment method (M) can be performed by attaching the flat secondary battery as described for the device (D). The matters described for device (D) are applicable to attachment method (M), and thus may be described without duplicated description. Attachment method (M) enables obtaining the effects described for device (D).

Examples of a configuration and a constituent element of device (D) according to the present exemplary embodiment will be described below. However, the configuration and the configuration element of device (D) are not limited to the description below. As described above, the description below is also applicable to attachment method (M).

### Flat Secondary Battery

The flat secondary battery has a circular planar shape. Examples of the flat secondary battery include a coin-shaped secondary battery and a button-shaped secondary battery. The flat secondary battery may be an aqueous solution secondary battery, a nonaqueous electrolyte secondary battery, a lithium secondary battery, or a lithium ion secondary battery. The lithium ion secondary battery is not particularly limited, and a known lithium ion secondary battery may be used. For example, a known coin-shaped lithium ion secondary battery using lithium titanate for a negative electrode active material may be used. A method for manufacturing the flat secondary battery is not limited, and the flat secondary battery may be manufactured by a known method.

The flat secondary battery includes a positive electrode, a negative electrode, an electrolyte, and an exterior body. A separator can be disposed between the positive electrode and the negative electrode. Matters other than essential matters for the exemplary embodiment of the present disclosure are not particularly limited, and a known configuration and a constituent element may be applied.

The positive electrode contains a positive electrode mixture, and the positive electrode mixture contains a positive electrode active material. As the positive electrode active material, a material in and from which lithium ions are occluded and released can be used. Examples of the positive electrode active material include a composite oxide containing at least one selected from a group consisting of Ni, Co, Mn, and Al, and lithium, and examples of the composite oxide include lithium cobaltate, lithium manganate, ternary nickel-manganese-cobalt lithium composite oxide, olivine type lithium iron phosphate, and lithium cobalt phosphate. The positive electrode mixture may contain various additives (e.g., a binder and a conductive material) in addition to the positive electrode active material. Alternatively, a positive electrode mixture containing only a positive electrode active material without various additives may be sintered and used as a positive electrode. The negative electrode contains a negative electrode mixture, and the negative electrode mixture contains a negative electrode active material. The negative electrode mixture may contain various additives (e.g., a binder and a conductive material) in addition to the negative electrode active material. Alternatively, a negative electrode mixture containing only a negative electrode active material without various additives may be sintered and used as a negative electrode. Each of the positive electrode and the negative electrode may be formed in a columnar shape. Then, using the positive electrode and the negative electrode formed in a columnar shape reduces influence of deviation of distribution of an electrolytic solution due to the centrifugal force.

As the negative electrode active material, lithium metal or a lithium alloy may be used. However, when the lithium metal is used, capacity reduction due to dendrite formation tends to occur. When the lithium alloy is used, the negative electrode active material is pulverized by expansion and contraction of the negative electrode active material during charging and discharging. As a result, discharge capacity is likely to decrease. From the viewpoint of breakage of components inside the battery due to external impact or vibration, a lithium-alloy type material is more subject to influence. Thus, an oxide capable of reversibly occluding and releasing lithium ions (e.g., a transition metal oxide) is preferably used as the negative electrode active material. The transition metal oxide contains at least a transition metal, and may contain an element other than the transition metal. Examples of the oxide (for example, transition metal oxide) of the negative electrode active material include SiO, SnO, CuO, Cu₂O, Fe₂O₃, Fe₃O₄, ZnO, PbO, MoO, MoO₂, TiO₂, Nb₂O₅, TiNb₂O₇, Li₄Ti₂O12, Li₂TiO₃, and Li_{1.4}Al_{0.4}Ti_{1.6}(PO₄)₃. Examples of an element that may be added to the oxide include at least one selected from a group consisting of Fe, Mn, Ni, Co, Sc, Y, Cu, Zn, Al, Cr, Pb, Sb, Mg, and B. The oxide preferably has a potential of 1 V or more with respect to metal lithium and are less likely to cause reductive decomposition of a nonaqueous electrolytic solution or a solid electrolyte, and preferable examples of the oxide include MoO, MoO₂, TiO₂, Nb₂O₅, TiNb₂O₇, Li₄Ti₂O12, Li₂TiO₃, and Li_{1.4}Al_{0.4}Ti_{1.6}(PO₄)₃. The negative electrode active material also may be a composite oxide containing lithium and titanium having very small expansion and contraction (i.e., volume change) during charging and discharging, or may be a composite oxide of lithium and titanium.

Examples of the composite oxide include lithium titanate, and specifically include lithium titanate with an initial state represented by Li₄Ti₂O12. Although Ti may be partially substituted with a different element, the different element has a smaller content than Ti. Examples of the different element include at least one selected from the group consisting of Fe, Mn, Ni, Co, Sc, Y, Cu, Zn, Al, Cr, Pb, Sb, Mg, and B.

Available examples of the electrolyte include: a nonaqueous electrolytic solution in which a lithium salt is dissolved in a nonaqueous solvent; a solid electrolyte such as an inorganic solid electrolyte containing lithium such as a sulfide-based electrolyte, oxide-based electrolyte, or chloride-based electrolyte, and a polymer solid electrolyte containing lithium; and an ionic liquid. The solid electrolyte is more preferable, since the influence of deviation of distribution of an electrolytic solution due to the centrifugal force can be completely ignored. The separator may be formed using a nonwoven fabric or a microporous membrane made of an insulating material (e.g., an insulating resin), examples of the insulating material including: an olefin-based material such as polypropylene, or polyethylene; an engineering plastic material such as polyphenylene sulfide or polyether ether ketone; a cellulose-based material; and an inorganic material such as glass.

The exterior body includes the positive electrode can having a bottomed cylindrical shape and the negative electrode can having a bottomed cylindrical shape. The positive electrode can and the negative electrode can are disposed so as to face each other in such a way that a gasket is provided therebetween. Thus, the exterior body having a coin shape or a button shape is constituted. The positive electrode mixture is disposed close to the positive electrode can, and the negative electrode mixture is disposed close to the negative electrode can. Materials of the positive electrode can, the negative electrode can, and the gasket are not particularly limited, and known materials used therefor may be used. However, the positive electrode can and the negative electrode can are each preferably made of the material described above (e.g., austenitic stainless steel or nickel alloy). The gasket is preferably made of a material that can withstand operation temperature (150° C. or higher) of the flat secondary battery. Examples the material include engineering plastics such as polyphyllesulfide (PPS), polyetheretherketone (PEEK), and a copolymer (PFA) of tetrafluoroethylene, and perfluoroether, and olefin-based materials. Additionally, materials obtained by adding glass or a filler to the above materials are also available.

The positive electrode can is allowed to function as a positive electrode terminal, and the negative electrode can is allowed to function as a negative electrode terminal.

Between the positive electrode mixture and the positive electrode can, a conductive layer (e.g., a carbon layer and a current collector) may be disposed. A conductive layer (e.g., a carbon layer and a current collector) may be disposed between the negative electrode mixture and the negative electrode can.

The positive electrode can is preferably disposed so as to face the substrate. The positive electrode can usually has a bottom surface disposed substantially parallel to the substrate. However, the bottom surface may be inclined to some extent (e.g., at an angle of 30° or less) from a state of being substantially parallel to the substrate.

### Substrate

The substrate is not particularly limited as long as the substrate can stably hold the flat secondary battery. As the substrate, a known substrate may be used. Examples of the substrate include a known substrate used as a printed substrate. Examples of a material of the substrate include paper, resin, glass, and ceramics. The substrate may be made of at least one of these materials. The substrate includes electrical wiring.

### Electronic Components Other Than Flat Secondary Battery

Device (D) may include an electronic component, which may constitute an electronic device, other than the flat secondary battery according to its purpose. Examples of such an electronic component include a sensor, cameras, a power receiver, a transmitter, and a processor. Electric power is supplied from the flat secondary battery to the electronic component as necessary.

Examples of the sensor include a sensor for monitoring a rotational position, a pressure sensor, an acceleration sensor, a temperature sensor, and a position sensor. The pressure sensor is used for monitoring pressure in a tire, for example. The transmitter is an element for transmitting various types of information (e.g., information obtained by a sensor) to a reception unit, and includes an antenna. The processor performs various types of processing and control. For example, the processor transmits information output from the sensor through the antenna. As the processor, an integrated circuit (IC) may be used.

The information transmitted from the transmitter is received by the reception unit disposed in a machine body (e.g., a vehicle body or an FA device), for example. The received information is processed and utilized by a control device disposed in a machine including a rotary part.

The flat secondary battery of device (D) is charged by wireless power feeding using electromagnetic induction such as magnetic resonance or magnetic field coupling. Thus, a power transmission unit (e.g., coil, antenna) for wireless power supply is disposed in the machine body (e.g., a vehicle body or an FA device). The power receiver generates electric power by using electromagnetic induction. Examples of the power receiver include a coil and an antenna.

### Terminal

One end of each of terminals (i.e., lead terminals) can be connected to corresponding one of the positive electrode can and the negative electrode can. The other end of each of the terminals can be connected to the electrical wiring of the substrate. The terminals are not particularly limited in shape as long as they can be electrically connected. For example, a terminal made of metal such as stainless steel can be used as each of the terminals. For wireless power feeding using electromagnetic induction such as magnetic resonance or magnetic field coupling, a material having weak magnetism is particularly preferable. The terminals may be each independently made of a material that is at least one selected from the group consisting of austenitic stainless steel, two-phase stainless steel composed of austenitic stainless steel and ferritic stainless steel, and nickel alloy. The material of the positive electrode can and the negative electrode can may be the same as or different from each other. The terminals are connected to the respective exterior cans of the flat secondary battery by resistance welding or laser welding, for example. The substrate and the terminals are electrically connected by soldering the terminals to the substrate, for example.

### Battery Holder

The battery holder may be attached to the substrate so that a unit cell is inserted into the battery holder to be in electrical contact with the substrate. The battery holder includes terminal parts that are in contact with the battery and that are made of metal such as stainless steel. For wireless power feeding using electromagnetic induction such as magnetic resonance or magnetic field coupling, a material having weak magnetism is particularly preferable. The terminals may be each independently made of a material that is at least one selected from the group consisting of austenitic stainless steel, two-phase stainless steel composed of austenitic stainless steel and ferritic stainless steel, and nickel alloy.

### Resin

Device (D) may include a resin covering the flat secondary battery and/or the electronic component. As the resin, a resin used for sealing an electronic component may be used. Examples of the resin include an epoxy resin and a silicone resin. The resin may contain a filler such as inorganic particles.

The resin may be disposed between the substrate and the flat secondary battery. The resin may be disposed so as to surround a periphery of the flat secondary battery. The resin may be disposed so as to surround a periphery of the flat secondary battery and the terminals connected thereto. This configuration particularly makes it possible to prevent the flat secondary battery from being disconnected from the terminals or from being disengaged from the battery holder. When device (D) includes a housing surrounding the flat secondary battery, the housing may be internally filled with a resin.

### Housing

Device (D) may include a housing surrounding the flat secondary battery. The housing may partially surround device (D) or may surround the whole of device (D). However, the housing is selected in such a way that wireless power supply using electromagnetic induction is allowed. The housing is not particularly limited, and may be made of metal and/or resin.

Hereinafter, an example of the exemplary embodiment according to the present disclosure will be specifically described with reference to the drawings. The exemplary embodiment described below can be modified based on the above description. Matters described below may be applied to the exemplary embodiment described above. The exemplary embodiment may be described below without matters that are not essential to the invention according to the present disclosure.

### First Exemplary Embodiment

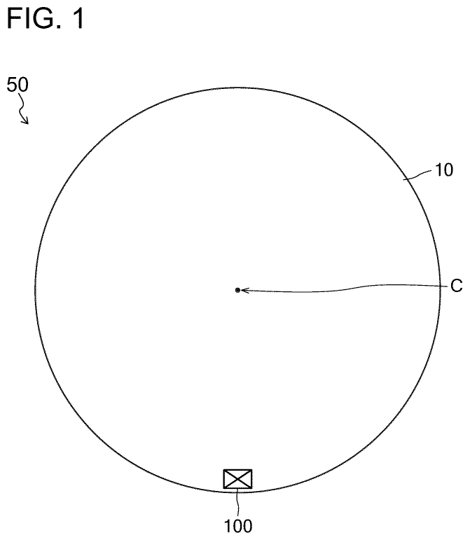

A first exemplary embodiment will be described for examples of device (D) and attachment method (M). FIG. 1 shows a side view of an example of rotary part 10 to which device 100 is attached. Rotary body 50 includes rotary part 10 and device 100 fixed to rotary part 10. FIG. 1 illustrates only an outline of an outer edge of rotary part 10. Rotary part 10 is configured to rotate about rotation center C.

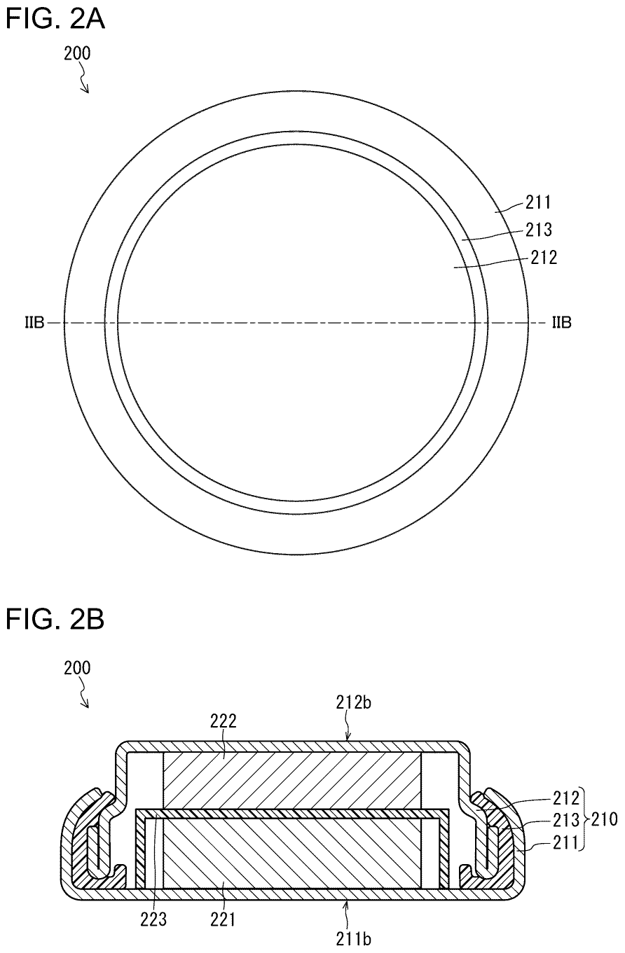

Device 100 includes flat secondary battery 200. FIG. 2A shows a top view of secondary battery 200, and FIG. 2B shows a cross-sectional view taken along line IIB-IIB in FIG. 2A. As shown in FIGS. 2A and 2B, secondary battery 200 has a coin shape (i.e., low columnar shape).

Secondary battery 200 includes exterior body 210, positive electrode 221, negative electrode 222, separator 223, and a nonaqueous electrolyte. Exterior body 210 includes positive electrode can 211 having a bottomed cylindrical shape, negative electrode can 212 having a bottomed cylindrical shape, and gasket 213. Exterior body 210 in a coin shape is formed by allowing positive electrode can 211 and negative electrode can 212 to face each other in such a manner that a gasket is provided between positive electrode can 211 and negative electrode can 212.

Positive electrode can 211 includes bottom surface 211b having a circular shape and a cylindrical part rising from an outer edge part of bottom surface 211b. Negative electrode can 212 includes bottom surface 212b having a circular shape and a cylindrical part rising from an outer edge part of bottom surface 212b. FIG. 2B shows an example in which at least a part of the cylindrical part of negative electrode can 212 is disposed inside the cylindrical part of positive electrode can 211. Positive electrode can 211 and negative electrode can 212 are each made of SUS316L of austenitic stainless steel.

Positive electrode 221 and negative electrode 222 are respectively formed by molding a positive electrode mixture and a negative electrode mixture into cylindrical shapes. After that, drying is performed at a high temperature of 100° C. or higher. The positive electrode mixture contains lithium cobalt oxide as an active material, acetylene black as a conductive agent, and a fluorine-based resin as a binder. The negative electrode mixture contains lithium titanate as an active material, acetylene black as a conductive agent, and a rubber-based material as a binder. The battery has a voltage of 2.6 V in a charged state. Positive electrode 221 is disposed close to positive electrode can 211. Positive electrode 221 faces and is in contact with positive electrode can 211. Negative electrode 222 is disposed close to negative electrode can 212. Negative electrode 222 faces and is in contact with negative electrode can 212. Separator 223 is disposed between positive electrode 221 and negative electrode 222. Separator 223, positive electrode 221, and negative electrode 222 are each filled with a nonaqueous electrolytic solution.

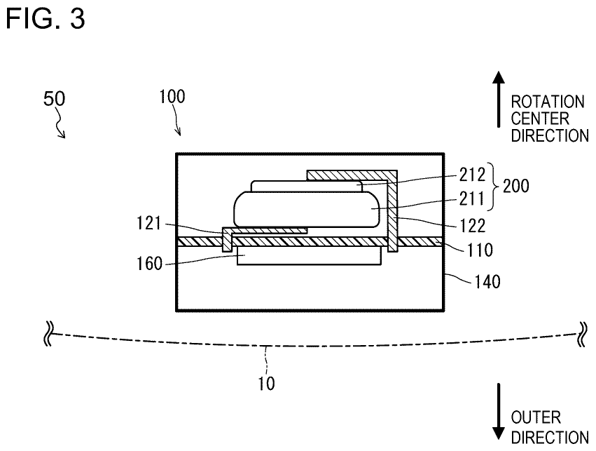

FIG. 3 schematically illustrates an example of a configuration and placement of device 100. Hatching is not partially illustrated in the drawing below for easy viewing. FIG. 3 illustrates only a part of the outline of the outer edge of rotary part 10. With reference to FIG. 3, device 100 includes substrate 110, terminals (i.e., lead terminals) 121 and 122, housing 140, power receiver 160, and flat secondary battery 200.

The first exemplary embodiment shows an example in which substrate 110 is provided with power receiver 160 and secondary battery 200. Alternatively, at least a part of power receiver 160 may be disposed on or over a surface of the substrate 110 on or over which secondary battery 200 is provided. Power receiver 160 is connected to secondary battery 200 through wiring.

Housing 140 surrounds secondary battery 200 and functions as an exterior body of device 100. Secondary battery 200 is soldered to wiring of substrate 110 with terminal 121 connected to positive electrode can 211 and terminal 122 connected to negative electrode can 212. Terminals 121 and 122 are each made of SUS304 of austenitic stainless steel. Electric power received by power receiver 160 is supplied to secondary battery 200 through terminals 121 and 122. Shapes of terminals 121 and 122 and connection positions to the exterior cans are not limited to an example illustrated in FIG. 3.

Secondary battery 200 is disposed closer to the inside, namely, closer to rotation center C than substrate 110 is as viewed from rotation center C of rotary part 10. Thus, heating of the secondary battery due to magnetic flux of electromagnetic induction such as magnetic resonance or magnetic field coupling from the outside is reduced. Secondary battery 200 is disposed in such a way that positive electrode can 211 faces substrate 110. Negative electrode can 212 is located between positive electrode can 211 and substrate 110. Furthermore, reaction between the negative electrode and the electrolytic solution in a charged state at high temperature can also be suppressed. In addition, by using a material having weak magnetism for each of the exterior cans and the terminals, heating by magnetic flux can be reduced.

The invention of PTL 1 is for preventing damage of components inside a battery due to impact or vibration from the outside of a tire, and charging by electromagnetic induction such as magnetic resonance or magnetic field coupling is not assumed in this configuration, and thus a secondary battery is heated by magnetic flux and deterioration of the battery is accelerated. For this reason, the secondary battery is required to be replaced in a short time. Additionally, swelling of the battery more than expected (at a temperature equal to or higher than ambient environment) may cause peeling of a connection part between the substrate and the terminal or cracking of the substrate. The heating by magnetic flux also may cause thermal degradation to other components mounted together on the substrate. Although the invention of PTL 2 has proposed a secondary battery for a rotary part, a device in which charging is taken into consideration is not assumed. The present invention provides a rotary body including a device using charging by using electromagnetic induction in an actual rotary part, the device having high power reception efficiency, the device being reduced in deterioration of a secondary battery due to heat, and the device having high reliability for a long term without requiring battery replacement.

### Supplement

The description above discloses techniques below.

### Technique 1

A rotary body including:
a rotary part configured to rotate about a rotation center; and
a device fixed to the rotary part,
the device including:
a substrate;
a power receiver; and
a flat secondary battery attached to the substrate,
the power receiver having a structure for receiving power supply using electromagnetic induction,
the flat secondary battery including an exterior body including a positive electrode can having a bottomed cylindrical shape and a negative electrode can having a bottomed cylindrical shape, and
the flat secondary battery being disposed closer to the rotation center than the substrate is as viewed from the rotation center of the rotary part.

### Technique 2

The rotary body according to technique 1, wherein the power receiver is disposed farther away than the substrate in the rotary part as viewed from the rotation center of the rotary part.

### Technique 3

The rotary body according to technique 1 or 2, wherein the positive electrode can faces the substrate.

### Technique 4

The rotary body according to technique 3, wherein the positive electrode can is disposed between the negative electrode can and the substrate.

### Technique 5

The rotary body according to any one of the techniques 1 to 4, in which
the positive electrode can is made of a material that is at least one selected from a group consisting of austenitic stainless steel, two-phase stainless steel composed of austenitic stainless steel and ferritic stainless steel, and nickel alloy, and
the negative electrode can is made of a material that is at least one selected from a group consisting of austenitic stainless steel, two-phase stainless steel composed of austenitic stainless steel and ferritic stainless steel, and nickel alloy.

### Technique 6

The rotary body according to any one of techniques 1 to 5, wherein the rotary part is a tire.

### Technique 7

The rotary body according to any one of techniques 1 to 5, wherein the rotary part is a rotary part provided in a factory automation device.

### Technique 8

A method for manufacturing a rotary body, the method comprising:
preparing a device including a substrate, a power receiver, and a flat secondary battery attached to the substrate;
preparing a rotary part configured to rotate about a rotation center; and
fixing the device to the rotary part,
wherein the power receiver has a structure for receiving power supply using electromagnetic induction,
the flat secondary battery includes an exterior body including a positive electrode can having a bottomed cylindrical shape and a negative electrode can having a bottomed cylindrical shape, and
the fixing the device to the rotary part includes fixing the device to the rotary part in such a manner that the flat secondary battery is disposed closer to the rotation center than the substrate is as viewed from the rotation center of the rotary part.

### Technique 9

The method for manufacturing a rotary body, according to technique 8, wherein the power receiver is disposed farther away than the substrate as viewed from the rotation center of the rotary part.

### Technique 10

The method for manufacturing a rotary body, according to technique 8 or 9,wherein the positive electrode can faces the substrate.

### Technique 11

The method for manufacturing a rotary body, according to technique 10, wherein the positive electrode can is disposed between the negative electrode can and the substrate.

### Technique 12

The method for manufacturing a rotary body, according to any one of the techniques 8 to 11, wherein
the positive electrode can is made of a material that is at least one selected from a group consisting of austenitic stainless steel, two-phase stainless steel composed of austenitic stainless steel and ferritic stainless steel, and nickel alloy, and
the negative electrode can is made of a material that is at least one selected from a group consisting of austenitic stainless steel, two-phase stainless steel composed of austenitic stainless steel and ferritic stainless steel, and nickel alloy.

### Technique 13

The method for manufacturing a rotary body, according to any one of the techniques 8 to 12, wherein the rotary part is a tire.

### Technique 14

The method for manufacturing a rotary body, according to any one of the techniques 8 to 12, wherein the rotary part is a rotary part provided in a factory automation device.

### INDUSTRIAL APPLICABILITY

The present disclosure is available for a rotary body including a device attached to a rotary part, and a method for manufacturing the rotary body.

### REFERENCE MARKS IN THE DRAWINGS

10: rotary part
50: rotary body
100: device
110: substrate
121, 122: terminal
140: housing
160: power receiver
200: flat secondary battery
210: exterior body
211: positive electrode can
212: negative electrode can
213: gasket
221: positive electrode
222: negative electrode
223: separator
C: rotation center

1. A rotary body comprising:
a rotary part configured to rotate about a rotation center; and
a device fixed to the rotary part,
wherein
the device including:
a substrate;
a power receiver; and
a flat secondary battery attached to the substrate,
the power receiver has a structure for receiving power supply using electromagnetic induction,
the flat secondary battery includes an exterior body including a positive electrode can having a bottomed cylindrical shape and a negative electrode can having a bottomed cylindrical shape, and
the flat secondary battery is disposed closer to the rotation center than the substrate is as viewed from the rotation center of the rotary part.

2. The rotary body according to claim 1, wherein
the power receiver is disposed farther away than the substrate in the rotary part as viewed from the rotation center of the rotary part.

3. The rotary body according to claim 1, wherein
the positive electrode can faces the substrate.

4. The rotary body according to claim 3, wherein
the positive electrode can is disposed between the negative electrode can and the substrate.

5. The rotary body according to claim 1, wherein
the positive electrode can is made of a material that is at least one selected from a group consisting of austenitic stainless steel, two-phase stainless steel composed of austenitic stainless steel and ferritic stainless steel, and nickel alloy, and
the negative electrode can is made of a material that is at least one selected from a group consisting of austenitic stainless steel, two-phase stainless steel composed of austenitic stainless steel and ferritic stainless steel, and nickel alloy.

6. The rotary body according to claim 1, wherein the rotary part is a tire.

7. The rotary body according to claim 1, wherein
the rotary part is a rotary part provided in a factory automation device.

8. A method for manufacturing a rotary body, the method comprising:
preparing a device including a substrate, a power receiver, and a flat secondary battery attached to the substrate;
preparing a rotary part configured to rotate about a rotation center; and
fixing the device to the rotary part,
wherein
the power receiver has a structure for receiving power supply using electromagnetic induction,
the flat secondary battery includes an exterior body including a positive electrode can having a bottomed cylindrical shape and a negative electrode can having a bottomed cylindrical shape, and
the fixing the device to the rotary part includes fixing the device to the rotary part in such a manner that the flat secondary battery is disposed closer to the rotation center than the substrate is as viewed from the rotation center of the rotary part.

9. The method for manufacturing a rotary body, according to claim 8, wherein
the power receiver is disposed farther away than the substrate as viewed from the rotation center of the rotary part.

10. The method for manufacturing a rotary body, according to claim 8, wherein
the positive electrode can faces the substrate.

11. The method for manufacturing a rotary body, according to claim 10, wherein
the positive electrode can is disposed between the negative electrode can and the substrate.

12. The method for manufacturing a rotary body, according to claim 8, wherein
the positive electrode can is made of a material that is at least one selected from a group consisting of austenitic stainless steel, two-phase stainless steel composed of austenitic stainless steel and ferritic stainless steel, and nickel alloy, and
the negative electrode can is made of a material that is at least one selected from a group consisting of austenitic stainless steel, two-phase stainless steel composed of austenitic stainless steel and ferritic stainless steel, and nickel alloy.

13. The method for manufacturing a rotary body, according to claim 8, wherein
the rotary part is a tire.

14. The method for manufacturing a rotary body, according to claim 8, wherein
the rotary part is a rotary part provided in a factory automation device.
